(19) United States
(12) Patent Application Publication
(10) Pub. No.: US 2007/0070494 A1
(43) Pub. Date: Mar. 29, 2007

(54) Multilayer optical interference film

(76) Inventors: Robert L. Brott, Woodbury, MN (US); Yaoqi Joe Liu, Shoreview, MN (US); Jeffrey J. Cernohous, Hudson, WI (US); Ying-Yuh Lu, Woodbury, MN (US); Robert S. Moshrefzadeh, Oakdale, MN (US); Kevin R. Schaffer, Woodbury, MN (US)

Correspondence Address: 3M INNOVATIVE PROPERTIES COMPANY, PO BOX 33427, ST. PAUL, MN, 55133-3427, US

(21) Appl. No.: 11/236,337

(22) Filed: Sep. 27, 2005

(51) Int. Cl. G02B 13/14

(52) U.S. Cl. 359/357; 359/580

(57) ABSTRACT

A multilayer optical film is disclosed. The multilayer film includes at least two adjacent optically transmissive tacky adhesive layers. Each tacky adhesive layer reflects light by optical interference.

### FIELD OF THE INVENTION

The invention relates to multilayer optical films. The invention particularly relates to multilayer optical interference films incorporating tacky adhesive layers.

### BACKGROUND

Multilayer optical films are commonly used in commercial and consumer applications due to advantages of forming layers of different materials into a single composite film. Multilayer optical products are used, for example, in computers, touch screen displays, diffusers, polarizers, and mirrors. Advantages of multilayer constructions include desirable optical properties and mechanical strength.

Multilayer optical films are sometimes formed together, for example, by co-extrusion, are sometimes laminated from separate pre-formed film layers into a multilayer film construction, and are sometimes placed together and kept in contact using an adhesive layer that may have optical properties.

### SUMMARY

Generally, the present invention relates to multilayer optical films. In one embodiment of the invention, a multilayer optical film includes at least two optically transmissive tacky adhesive layers. Each tacky adhesive layer reflects light by optical interference.

In another embodiment of the invention, a multilayer optical interference film includes two or more optically transmissive tacky adhesive layers. At least two tacky adhesive layers are adjacent to each other, each of which reflects light by optical interference.

### BRIEF DESCRIPTION OF THE DRAWINGS

The invention may be more completely understood and appreciated in consideration of the following detailed description of various embodiments of the invention in connection with the accompanying drawings, in which:

FIG. 1 is a schematic side-view of a multilayer optical film in accordance with one embodiment of the invention.

### DETAILED DESCRIPTION

The present invention generally relates to multilayer optical films. The invention is particularly applicable to multilayer optical interference films incorporating tacky adhesive layers.

Multilayer optical films are commonly used to, for example, polarize, reflect, or filter an incident beam of light. For example, U.S. Pat. No. 6,407,862 describes an electronic projection system that includes a specularly reflective mirror made of a multilayered polymeric material, where the mirror has high and uniform reflectivity over the visible spectrum from about 400 nm to about 700 nm. As another example, U.S. Pat. No. 6,088,067 describes a liquid crystal display (LCD) projection system that includes a reflective polarizer where the polarizer is a multilayer optical film.

In optical systems, it is often desirable to laminate adjacent layers by using an adhesive. The lamination may be desirable to, for example, improve structural integrity, provide surface protection, or reduce glare. For example, U.S. Pat. No. 6,459,514 describes adhesives useful for laminating a multilayer polymeric film to another surface, where the adhesive provides useful mechanical or chemical properties, without contributing to the primary optical function of the optical stack itself.

The present invention combines the primary optical function of a multilayer optical film with the often need to laminate the multilayer optical film to another surface by describing a multilayer optical film where many of the layers, preferably including the outermost layers, are tacky adhesive. According to one embodiment of the invention, a multilayer optical film provides both adhesion properties and primary optical functions of a multilayer optical film as desired in a given application. One advantage of the invention is lower cost and reduced overall thickness by eliminating or reducing the need for an adhesive layer to laminate a multilayer optical film to a surface. A multilayer optical film according to one embodiment of the invention can provide sufficient adhesion to an adherand by including a plurality of adhesive layers, even though an individual layer in the optical film may not be sufficiently thick to provide adequate adhesion by itself.

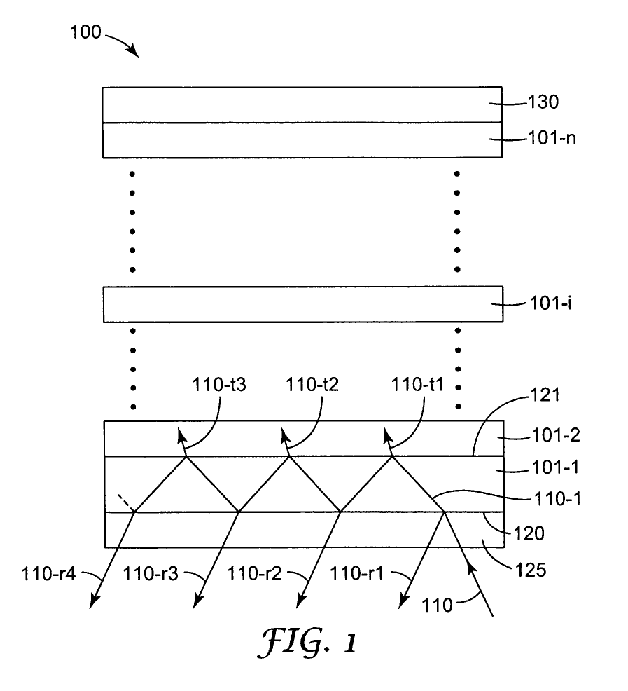

FIG. 1 is a schematic side-view of a multilayer optical interference film 100 in accordance with one embodiment of the invention. The interference film 100 includes a first optically transmissive outermost layer 125, a second optically transmissive outermost layer 130 and “n” internal optical layers 101-1 through 101-n where n is at least two. In particular, FIG. 1 shows a first internal optical layer 101-1, a second internal optical layer 101-2, an ith internal optical layer 101-i, and an nth internal optical layer 101-n. For simplicity, and without loss of generality, internal optical layers in between layers 101-2 and 101-i (layers 101-3 through 101-(i−1)), and internal optical layers in between layers 101-i and 101-n (layers 101-(i+1) through 101-(n−1)) are not shown in FIG. 1.

According to one embodiment of the invention, a plurality of the internal optical layers are adhesive, preferable tacky adhesive. As used herein, the term tacky adhesive refers to an adhesive that displays tack, where tack refers to a property of an adhesive that enables the adhesive to form a bond of measurable strength to an adherand immediately after the adhesive and the adherand are brought into contact under light pressure. Examples of a tacky adhesive include a pressure sensitive adhesive.

As used in the present description, the phrase “pressure sensitive adhesive” means an adhesive that displays permanent and aggressive tackiness to a wide variety of substrates after applying only light pressure. A pressure sensitive adhesive has a four-fold balance of adhesion, cohesion, stretchiness, and elasticity, and is normally tacky at use temperatures, which is typically room temperature (i.e., about 20° C. to about 30° C.). A pressure sensitive adhesive also typically has an open-time tack (i.e., a period of time during which the adhesive is tacky at room temperature) on the order of days and often months or years. An accepted quantitative description of a pressure sensitive adhesive is given by the Dahlquist criterion line (as described in Handbook of Pressure Sensitive Adhesive Technology, Second Edition, D. Satas, ed., Van Nostrand Reinhold, New York, N.Y., 1989, pages 171-176), which indicates that materials having a storage modulus (G′) of less than about 3×10⁵ Pascals (measured at 10 radians/second at a temperature of about 20° C. to about 22° C.) typically have pressure sensitive adhesive properties while materials having a G′ in excess of this value typically do not.

According to one embodiment of the invention, some of the internal optical layers in optical interference film 100 are not tacky adhesives, although they may be considered adhesives because of their ability to join the neighboring layers together by means of surface attachment.

According to one embodiment of the invention, at least one tacky adhesive internal layer, preferably each of a plurality of tacky adhesive internal layers, and even more preferably each tacky adhesive internal layer reflects light by optical interference. In general, an optical interference occurs when the total light intensity of two or more overlapping light beams depends, at least in part, on interference between the overlapping light beams. In an optical interference, the total light intensity is not necessarily the sum of the individual light beam intensities. For example, the total intensity can be more than the sum of the individual light beam intensities, less than the sum of the individual light beam intensities, or even zero. Optical interference generally occurs when there is a phase relation between the individual light beams. In other words, an optical interference can occur when the total light intensity of two or more overlapping light beams at a location is, at least in part, a function of both the amplitude and phase of the individual light beams.

In general, a beam of light incident on a layer undergoes multiple reflections within the layer from the two major surfaces of the layer resulting in multiple light beams reflected by the layer and multiple light beams transmitted by the layer. The total light reflected by the layer is the sum of all the individual light beams reflected by the layer. Similarly, the total light transmitted by the layer is the sum of all the individual light beams transmitted by the layer. As used herein, the layer reflects light by optical interference if there is interference between the individual light beams reflected by the layer, meaning that the intensity of the total reflected light is, at least in part, a function of both the amplitude and phase of the individual reflected light beams. As such, the intensity of the total reflected light intensity is not necessarily the sum of the individual reflected light beam intensities. For example, the total reflected light intensity can be more than the sum of the individual reflected light beam intensities, less than the sum of the individual reflected light beam intensities, or even zero. According to the invention, the layer reflects light by optical interference even where the total reflected light intensity is zero or near zero.

In terms of coherence, the term optical interference, as used herein, means that an incoherent analysis is generally not sufficient to sufficiently predict or describe all the reflective properties of a layer that reflects light by optical interference in a desired region of the spectrum. Rather, a coherent approach is required to accurately predict or explain observed or measured reflective characteristics of the layer in the desired region of the spectrum. As used herein, an incoherent approach means that the amplitude or intensity of the individual reflected and transmitted rays can sufficiently determine or predict reflective and transmissive characteristics of the layer. In contrast, a coherent approach means that the phase and the amplitude of the individual reflected and transmitted rays must be accounted for to accurately determine or predict reflective and transmissive characteristics of the layer.

In general, whether an incoherent approach can sufficiently predict reflective characteristics of a layer depends on a number of factors including the wavelength range of interest and the optical thickness of the layer where optical thickness is a product of the layer's thickness and the index of refraction of the layer material at a wavelength in the wavelength range of interest. In general, if the optical thickness of a layer is sufficiently larger than a wavelength of interest, an incoherent approach can sufficiently predict reflective characteristics of the layer at the wavelength of interest. On the other hand, in general, if the optical thickness of a layer is comparable to or smaller than a wavelength of interest, the layer reflects light by optical interference and a coherent approach is required to sufficiently predict reflective characteristics of the layer at the wavelength of interest.

The optical thickness of a layer can affect the peak reflectance wavelength, the bandwidth (e.g., the full width at half maximum of the layer's reflectance curve), and the optical absorption of the layer if the layer is made of optically absorptive material. In some applications, the optical thickness of a layer in optical film 100 that reflects light by optical interference at a wavelength λ is less than about 2λ, in some other applications less than about 1.5λ, in some other applications less than about λ, and in still some other applications less than about 0.7λ. In some application, the optical thickness of a layer in optical film 100 that reflects light by optical interference at a wavelength λ is less than about 0.5λ, in some other applications less than about 0.2λ, and in some other applications less than about 0.1λ.

Internal optical layer 101-1 has an input face 120 and an output face 121, where input face 120 forms an interface between layers 125 and 101-1 and output face 121 forms an interface between layers 101-1 and 101-2. In general, light incident on an interface between two layers with different indices of refraction is at least partially reflected. Furthermore, in general, the magnitude of the reflected light increases as the difference between the two indices of refraction is increased.

A light ray 110 incident on layer 101-1 at interface 120 is partially reflected and partially transmitted at input face 120, producing a reflected ray 110-r1 and a transmitted ray 110-1, respectively. Transmitted ray 110-1 undergoes a number of successive reflections within layer 101-1 at partially reflecting faces 120 and 121, resulting in a number of successive rays reflected and transmitted by layer 101-1. The successive rays reflected by layer 101-1 include rays 110-r1, 110-r2, 110-r3, and 110-r4, and the successive rays transmitted by layer 101-1 include rays 110-t1, 110-t2, and 110-t3. In theory, there are an infinite such reflected and transmitted rays. In practice, however, it is often sufficient to consider only a few of such reflected and transmitted rays to sufficiently predict a measured or observed total reflection or transmission. This is so because the amplitude of a reflected or transmitted ray tends to significantly decrease with each successive reflection within layer 101-1. The total reflected light can be determined by adding all the rays reflected by layer 101-1. Similarly, the total transmitted light can be determined by adding all the rays transmitted by layer 101-1. Each reflected or transmitted ray has a magnitude and a phase. A coherent analysis for determining the total reflection or the total transmission requires that the phase of each reflected or transmitted ray be taken into account and incorporated in the analysis. In contrast, in an incoherent analysis the individual phase of the reflected and transmitted rays may be ignored and the analysis can be based only on the magnitude or amplitude of the individual rays.

According to one embodiment of the invention, exemplary internal optical layer 101-1 reflects light by optical interference, meaning that in determining the total light reflected by layer 101-1, the phase of each of the reflected rays (i.e., rays 110-r1, 110-r2, 110-r3, . . . ) must be included in the analysis to accurately predict or explain characteristics of a measured or observed reflected or transmitted light. In a coherent analysis, the reflected rays may add constructively or destructively at a wavelength of interest depending on the phase of the individual reflected rays at the wavelength.

Exemplary internal layer 101-1 can reflect light by optical interference in the visible region of the spectrum, typically, in a wavelength range from about 400 nm to about 700 nm. In some applications, internal layer 101-1 can reflect light by optical interference in the infrared region of the spectrum, typically, in a wavelength range from about 700 nm to about 3,000 nm.

Other layers in interference film 100 can have tacky adhesive properties and reflect light by optical interference. For example, all layers 101-1 through 101-n can be tacky adhesive layers and reflect light by optical interference where n is an integer greater than 1. In some applications, interference film 100 can have at least 3 tacky adhesive internal layers, at least 3 of which reflect light by optical interference. In some other applications, interference film 100 can have at least 5 tacky adhesive internal layers, at least 5 of which reflect light by optical interference. In yet some other applications, interference film 100 can have at least 7 tacky adhesive internal layers, at least 7 of which reflect light by optical interference. In general, interference film 100 can have at least “k” tacky adhesive internal layers, at least “k” of which reflect light by optical interference, where “k” is an integer greater than 1.

In general, adjacent layers in interference film 100 have different indices of refraction. In some applications, however, adjacent layers in interference film 100 can have the same index of refraction. For example, adjacent layers 101-1 and 101-2 can have the same index of refraction at a given wavelength. Adjacent layers may have the same index of refraction, for example, to improve mechanical and/or chemical properties. Where adjacent layers have the same index of refraction, the adjacent layers in combination can reflect light by optical interference.

According to one embodiment of the invention, a layer, including a tacky adhesive internal layer, in optical interference film 100 is isotropic, meaning that indices of refraction of the layer along any three mutually perpendicular directions are equal at a given wavelength. In some applications, a layer, including a tacky adhesive internal layer, in optical interference film 100 is anisotropic, meaning that indices of refraction of the layer along at least two mutually perpendicular directions are not equal at a given wavelength.

According to one embodiment of the invention, an optical thickness of a layer in interference film 100 that reflects light by optical interference, such as layer 101-i, is less than 2 microns at least one wavelength in a wavelength range from about 400 nm to about 700 nm, preferably less than about 1 micron, more preferably less than about 0.7 microns, more preferably less than about 0.5 microns, more preferably less than about 0.2 microns, and even more preferably less than about 0.1 microns.

According to one embodiment of the invention, an optical thickness of a layer in interference film 100 that reflects light by optical interference is less than 6 microns at least one wavelength in a range from about 700 nm to about 3000 nm, preferably less than about 4 micron, more preferably less than about 2 microns, and even more preferably less than about 1 micron.

According to one embodiment of the invention, an optical thickness of a layer in interference film 100 that reflects light by optical interference, such as layers 101-1 and 101-i, is a fraction of a wavelength λ_{O}, where λ_{O} can be a wavelength in the visible range of the spectrum, generally, in a wavelength range from about 400 nm to about 700 nm, such as 400 nm, 500 nm, 550 nm, or 600 nm. For example, the optical thickness of one or both of layers 101-1 and 101-i can be λₒ/4, λₒ/2, or 7λ_{O}/36.

According to one embodiment of the invention, λₒ can be a wavelength in the infrared region of the spectrum, typically in a wavelength range from about 700 nm to about 3,000 nm, such as 700 nm, 800 nm, 1000 nm, 1300 nm, 1500 nm, 2000 nm, 2500 nm, or 3000 nm.

According to one embodiment of the invention, each layer in interference film 100 that reflects light by optical interference has an optical thickness that is a fraction of at least one wavelength in a wavelength range from about 400 nm to about 700 nm. According to another embodiment of the invention, each layer in interference film 100 that reflects light by optical interference has an optical thickness that is a fraction of at least one wavelength in a wavelength range from about 700 nm to about 3000 nm.

According to one embodiment of the invention, at least one of outermost layers 125 and 130 reflects light by optical interference in a wavelength region of interest. Furthermore, at least one of the outermost layers is a tacky adhesive. In such a case, a tacky adhesive outermost layer can, for example, be used to bond interference film 100 to an element or a component.

In one embodiment of the invention, each layer in interference film 100 is optically transmissive, meaning that each layer transmits at least a significant portion of an incident light. The internal optical transmission of each layer (that is, transmission excluding losses due to surface reflections) is at least 50%, more preferably at least 80%, even more preferably at least 98%, even more preferably at least 99%, and even more preferably at least 99.5%.

The materials used for the layers of interference film 100 can be any materials useful in optical products, preferably having high optical transmissivity at desired wavelengths, and preferably having desired mechanical, adhesive, conductive, polarizing, diffusing, or other mechanical or optical properties. An optical layer in interference film 100 may be made of a material such as glass, an organic polymeric material such as a polyester, polycarbonate, or another organic or inorganic material. Tacky adhesive outermost layers of interference film 100, such as layer 125, can be used to bond optical components to one another while still providing useful optical properties. Adhesives may be of materials that exhibit structural or pressure sensitive adhesive properties, or a hybrid combination.

An advantage of the present invention is in providing optical layers in an interference film that perform multiple functions. For example, interference film 100 can have a plurality of tacky adhesive layers for bonding two different optical components, such as two lenses, or two substrates. At the same time, the tacky adhesive layers in interference film 100 can reflect and transmit light by optical interference. For example, interference film 100 can be used as an optical filter, for example, to reflect one region of the spectrum and transmit another. As another example, interference film 100 can be a mirror, a polarizer, or an anti-reflection film. For example, interference film 100 can have anti-reflection properties at least one wavelength in a wavelength range from about 400 nm to about 700 nm. In general, interference film 100 can be any optical element that employs optical interference to provide a desired optical property.

Interference film 100 can include a layer that does not reflect light by optical interference, meaning that an incoherent analysis can sufficiently predict or describe reflectance characteristics of the layer at a desired wavelength.

Typical indices of refraction for the materials used in interference film 100 may vary greatly depending on composition. Polymeric materials may exhibit refractive indices of from about 1.4 to about 1.5 (e.g., certain silicon polymers and polyacrylates) to about 1.87 (e.g., for uniaxially oriented polyethylene naphthalene)—many pressure sensitive adhesives fall into this range. Inorganic materials such as glass or an inorganic coating on any type of substrate, may have different ranges of indices of refraction. Inorganic coatings can exhibit indices of refraction in the range from about 1.5 or 1.8 up to about 2.2 (indium tin oxide) or even higher (e.g., 2.4). A material's index of refraction is a common property that is measurable by well known methods, such as by using a refractometer. Indices of refraction are also catalogued. See, e.g., J. Brandup and E. H. Immergut, Polymer Handbook John Wiley and Sons, pp. 453-461 (3d ed. 1989).

Interference film 100 may include optical layers that include organic polymers (e.g., homopolymers or copolymers, etc.) or inorganic materials such as glass, ceramic, inorganic coatings such as metal oxide coatings, or polycarbonate. Interference film 100 may include non-adhesive optical layers that act as support layers, polarizing layers, diffusing layers, reflective layers, transmissive layers that provide strength or support, conductive layers, antireflective layers, metal layers, light absorbing layers, etc. One or more of these non-adhesive layers may be used as an outer layer of interference film 100 or as an intermediate layer.

Any type of glass or optical ceramic can be used as a non-adhesive optical component, e.g., for support. Polymeric materials such as polyester (e.g., polyethylene naphthalate (PEN), polyethylene terephthalate, and the like), polyacrylates, polycarbonates, or other stiff or rigid materials such as film materials and polymeric materials. Polycarbonate layers may typically be used at a thickness in a range from about one or three millimeters up to any larger thickness; and polyacrylates such as polymethyl methacrylate, for example, can be useful at a thickness of at least about one to three millimeters up to any larger thickness. Typical indices of refraction of such materials may be above about 1.4, e.g., between about 1.48 and 1.6.

A non-adhesive or optical component layer may include an optical coating layer, an electrically conductive coating layer, or another type of coating layer. Examples of coated optical layers include glass or polyester coated with a conductive layer such as indium tin oxide (ITO).

Exemplary adhesive layers can be made of materials known to exhibit properties of structural adhesives, pressure sensitive adhesives, or hybrids of structural and pressure sensitive adhesives. An adhesive may be curable by various methods such as UV radiation, e-beam radiation, heat, etc.

Other polymeric or non-polymeric materials may be included in layers of interference film 100 without necessarily functioning as a tacky adhesive. These materials can be included to provide, e.g., mechanical properties, optical properties, or to facilitate processing. Examples may include plasticizers, tackifiers, cross-linkers, curing agents, nanoparticles, etc.

Interference film 100 can be prepared by methods that will be understood by the skilled artisan. Organic and inorganic, adhesive or non-adhesive layers can be arranged to produce useful inter-layer adhesion. Polymeric and adhesive layers can be prepared by producing a polymeric or adhesive layer, e.g., by coating or casting and solvent evaporation, by hot-melt methods, by various extrusion, blown extrusion, co-extrusion methods, or other known methods, as desired or useful. Adhesive or non-adhesive organic polymeric or inorganic layers can be laminated together before or after curing, as appropriate to create a useful amount of inter-layer adhesion.

Known co-extrusion methods may also be used to prepare multilayer materials having multiple layers of similar or dissimilar heat processable polymeric materials, by extruding different materials through a multiple port (e.g., slot) or multi-layer die. These methods can be useful to produce multilayer composites of different materials, with good interlayer adhesion.

Optical interference film 100 may include additional layers, not explicitly shown in FIG. 1, that are placed on at least one of outermost layers 125 and 130. Such additional layers can, for example, act as release layers which can be removed from the film at an appropriate time during processing or use.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A multilayer optical interference film comprising at least two adjacent optically transmissive tacky adhesive layers, each tacky adhesive layer reflecting light by optical interference.

2. The multilayer optical film of claim 1, wherein at least one tacky adhesive internal layer is a pressure sensitive adhesive layer.

3. The multilayer optical film of claim 1, wherein each tacky adhesive layer reflects light by optical interference in a wavelength range from about 400 nm to about 700 nm.

4. The multilayer optical film of claim 1, wherein each tacky adhesive layer reflects light by optical interference in a wavelength range from about 700 nm to about 3000 nm.

5. The multilayer optical film of claim 1, wherein the optical thickness of each tacky adhesive layer is less than about 0.5 microns at at least one wavelength in a wavelength range from about 400 nm to about 700 nm.

6. The multilayer optical film of claim 1, wherein the optical thickness of each tacky adhesive layer is less than about 0.2 microns at at least one wavelength in a wavelength range from about 400 nm to about 700 nm.

7. The multilayer optical film of claim 1, wherein the optical thickness of each tacky adhesive layer is less than about 0.1 microns at at least one wavelength in a wavelength range from about 400 nm to about 700 nm.

8. The multilayer optical film of claim 1, wherein the optical thickness of each tacky adhesive layer is less than about 4 micron at at least one wavelength in a wavelength range from about 700 nm to about 3000 nm.

9. The multilayer optical film of claim 1, wherein the optical thickness of each tacky adhesive layer is less than about 2 microns at at least one wavelength in a wavelength range from about 700 nm to about 3000 nm.

10. The multilayer optical film of claim 1, wherein the optical thickness of each tacky adhesive layer is less than about 1 micron at at least one wavelength in a wavelength range from about 700 nm to about 3000 nm.

11. The multilayer interference film of claim 1 comprising at least 5 adjacent tacky adhesive layers, each reflecting light by optical interference.

12. The multilayer interference film of claim 1 comprising at least 7 adjacent tacky adhesive layers, each reflecting light by optical interference.

13. The multilayer interference film of claim 1 comprising at least 9 adjacent tacky adhesive layers, each reflecting light by optical interference.

14. The multilayer interference film of any of claim 11, wherein each tacky adhesive layer that reflects light by optical interference has an optical thickness that is a fraction of a wavelength in a wavelength range from about 400 nm to about 700 nm.

15. The multilayer interference film of any of claim 12, wherein each tacky adhesive layer that reflects light by optical interference has an optical thickness that is a fraction of a wavelength in a wavelength range from about 400 nm to about 700 nm.

16. The multilayer interference film of any of claim 13, wherein each tacky adhesive layer that reflects light by optical interference has an optical thickness that is a fraction of a wavelength in a wavelength range from about 400 nm to about 700 nm.

17. The multilayer interference film of any of claim 11, wherein each tacky adhesive layer that reflects light by optical interference has an optical thickness that is a fraction of a wavelength in a wavelength range from about 700 nm to about 3000 nm.

18. The multilayer interference film of any of claim 12, wherein each tacky adhesive layer that reflects light by optical interference has an optical thickness that is a fraction of a wavelength in a wavelength range from about 700 nm to about 3000 nm.

19. The multilayer interference film of any of claim 13, wherein each tacky adhesive layer that reflects light by optical interference has an optical thickness that is a fraction of a wavelength in a wavelength range from about 700 nm to about 3000 nm.

20. The multilayer interference film of claim 1, wherein each layer of the multilayer film reflects light by optical interference.

21. The multilayer interference film of claim 1 having a first outermost layer and a second outermost layer, at least one of the first and second outermost layers being a tacky adhesive.

22. The multilayer interference film of claim 1 having a first outermost layer and a second outermost layer, at least one of the first and second outermost layers reflecting light by optical interference.

23. The multilayer interference film of claim 1, wherein at least one tacky adhesive layer is anisotropic.

24. The multilayer interference film of claim 1 having a first outermost layer, a second outermost layer, and removal release layers disposed on at least one of the first and second outermost layers.

25. A multilayer optical interference film comprising two or more optically transmissive tacky adhesive layers, at least two tacky adhesive layers being adjacent to each other, each of the at least two adjacent tacky adhesive layers reflecting light by optical interference.
